(19) United States
(12) Patent Application Publication
(10) Pub. No.: US 2014/0362605 A1
(43) Pub. Date: Dec. 11, 2014

(54) DUTY CONTROL METHOD AND SYSTEM FOR LOW VOLTAGE DC-DC CONVERTER

(71) Applicant: Hyundai Motor Company, Seoul (KR)

(72) Inventors: Hui Sung Jang, Hwaseong (KR); Shin Hye Chun, Gwangyang (KR); Mu Shin Kwak, Osan (KR); Hyun Wook Seong, Hwaseong (KR)

(73) Assignee: Hyundai Motor Company, Seoul (KR)

(21) Appl. No.: 14/096,368

(22) Filed: Dec. 4, 2013

(30) Foreign Application Priority Data
Jun. 10, 2013 (KR) 10-2013-0065635

(51) Int. Cl. H02M 3/335

(52) U.S. Cl. CPC H02M 3/33507; H02M 3/33569
USPC 363/17

(57) ABSTRACT

A duty control method for a low-voltage DC-DC converter (LDC) is provided in which a duty ratio of a high-efficiency and low-voltage DC-DC converter that has a boost converter and a full-bridge converter combined therein is variable-controlled to output low-voltage. In particular, control of a duty ratio of the LDC that includes a boost converter and a full-bridge converter or a half-bridge converter connected in series is improved and by controlling an output voltage of the full-bridge converter in a simple-equation-based variable-duty scheme to output a low voltage for high-voltage input, stable low-voltage output may be achieved over the input and output voltage range.

### CROSS-REFERENCE TO RELATED APPLICATION

This application claims under 35 U.S.C. §119(a) the benefit of Korean Patent Application No. 10-2013-0065635 filed on Jun. 10, 2013, the entire contents of which are incorporated herein by reference.

### BACKGROUND

(a) Technical Field

The present disclosure relates to a method and system for controlling a duty of a low-voltage direct current-direct current (DC-DC) converter, and more particularly, to a duty control method for a low-voltage DC-DC converter, in which a duty ratio of a high-efficiency and low-voltage DC-DC converter having a boost converter and a full-bridge converter combined therein is variable controlled to output low-voltage.

(b) Background Art

In a vehicle using electricity such as a Hybrid Electric Vehicle (HEV), a fuel-cell vehicle, or a fuel-cell hybrid vehicle, a low-voltage DC/DC Converter (LDC) that charges a 12V battery (e.g., secondary battery) and supplies power to a 12V electric-field load is installed. The LDC converts a high-voltage DC voltage from a high-voltage battery of the HEV into a low-voltage DC voltage and provides the low-voltage DC voltage to an electric field load of the vehicle, such as a secondary battery. More specifically, in the HEV, the LDC operates as an alternator of a general gasoline vehicle, causing the LDC to decrease the high voltage of a main battery to provide a voltage of 12V and to convert the high voltage DC of the regeneration energy of the main battery or a driving motor into 12V (DC) to charge the secondary battery or to supply power to the electric field load.

In an example of the LCD, as illustrated in FIGS. 1-3, a boost converter 20 connected with a main battery 10 to supply a boosting voltage to the load and a full-bridge converter 30 or a half-bridge converter connected with the boost converter 20 by a switch to output a transformed or rectified voltage to a secondary battery 40 or a load 50 are combined.

In particular, referring to FIG. 2, the full-bridge converter 30 includes a switch 32 that alternately switches and outputs DC, a transformer 34 that decrease an AC voltage output from the switch 32 to a 12V level that is available in the vehicle, and a rectifier 36 that rectifies the decreased voltage to a predetermined voltage. The LDC in which the boost converter and the full-bridge converter or the half-bridge converter are connected in series adopts, for high efficiency, a one-step duty control scheme that duty-controls the output voltage of the boost converter when the output voltage of the full-bridge converter is fixed to a maximum fixed duty.

However, due to unique characteristics of the boost stage of the LDC, that is, the boost converter, the output voltage of the boost converter may be greater than the input voltage, preventing the low-voltage output of the full-bridge converter in a control scheme using the duty ratio of the full-bridge converter as a maximum (Max) fixed duty ratio. In other words, the LDC operates in a wide input voltage range (e.g., 200-410V) according to the specification of the main battery, and may output an output voltage V_{O} as a low voltage for a low input voltage VIN, but may not output the low voltage for a high input voltage VIN, failing to generate a desired output voltage and thus causing excessive output voltage ripple, and over-temperature and over-current in each power element.

### SUMMARY

Accordingly, the present invention provides a duty control method and system for an LDC, in which control of a duty ratio of the LDC that includes a boost converter and a full-bridge converter or a half-bridge converter connected in series is improved and by controlling an output voltage of the full-bridge converter in an equation-based variable-duty scheme to output a low voltage even for high-voltage input, stable low-voltage output may be achieved over the input and output voltage range.

According to an aspect of the present invention, a duty control method and system for a low-voltage DC-DC converter (LDC) in which a boost converter boosts an input voltage (V_{IN}) from a main battery and is fed back with an output voltage (V_{O}) to perform closed-loop duty ratio control and a full-bridge (FB) converter or a half-bridge (HB) converter which performs open-loop effective duty ratio (D_{eff}) control and outputs a voltage to a secondary battery or a load are connected in series, may include closed-loop controlling and outputting the output voltage (V_{O}) of the LDC to a duty ratio in a predetermined range of the boost converter and variable-open-loop controlling and outputting the output voltage (V_{O}) of the FB converter to a variable-open-loop duty ratio that corresponds to the input voltage (V_{IN}) and the output voltage (V_{O}).

Further, when the input voltage (V_{IN}) is substantially low, an output voltage (V_{DC}) of the boost converter may be controlled to a duty ratio in a predetermined range and the output voltage (V_{O}) of the FB converter may be fixed to a maximum duty (D_{eff}_{_{—}}_{MAX}). When the input voltage (V_{IN}) increases, the output voltage (V_{O}) of the FB converter may be controlled to a variable-open-loop duty ratio, and as a duty of the FB converter varies with the increasing input voltage, the duty ratio of the boost converter may be determined by closed-loop control.

In addition, to the maintenance of the variable-open-loop duty ratio may include, as an equation-based variable duty control process, inputting the current input voltage (V_{IN}) and the output voltage (V_{O}) to the FB converter, calculating the effective duty ratio (D_{eff}) of the FB converter for variable duty control that corresponds to the input voltage (V_{IN}) and the output voltage (V_{O}), and controlling and outputting the output voltage (V_{O}) of the FB converter to the effective duty ratio (D_{eff}) when the effective duty ratio (D_{eff}) is less than or equal to the maximum effective duty ratio (D_{eff}_{_{—}}_{MAX}).

The effective duty ratio (D_{eff}) may be calculated as:

$${D}_{eff} = \frac{{V}_{O}}{{V}_{IN}} \times n \times ( 1 - {D}_{MIN} )$$

and calculated as an equation-based duty ratio that is maximal for each input voltage and
output voltage from

$${V}_{DC} = \frac{{V}_{IN}}{1 - D}$$

$$and$$

$${V}_{O} = {V}_{DC} \frac{{D}_{eff}}{n}$$

that are input/output equations between the boost converter and the FB converter.

### BRIEF DESCRIPTION OF THE DRAWINGS

The above and other features of the present invention will now be described in detail with reference to an exemplary embodiment thereof illustrated the accompanying drawings which are given hereinbelow by way of illustration only, and thus are not limitative of the present invention, and wherein:

FIG. 1 is an exemplary control diagram for duty control of a conventional LDC according to the related art;

FIG. 2 is an exemplary connection circuit diagram of a boost converter and a full-bridge converter that form the conventional LDC according to the related art;

FIG. 3 is an exemplary graph showing a duty control possible region and a duty control impossible region of the conventional LDC according to the related art;

FIG. 4 is an exemplary control diagram for duty control of an LDC according to an exemplary embodiment of the present invention;

FIG. 5 is an exemplary graph showing a duty control possible region of an LDC according to an exemplary embodiment of the present invention;

FIG. 6 is an exemplary flowchart showing a variable duty control process for a full-bridge converter of an LDC according to an exemplary embodiment of the present invention; and

FIGS. 7A and 7B are exemplary waveform diagrams illustrating a result of an experimental example of duty control of an LDC according to an exemplary embodiment of the present invention.

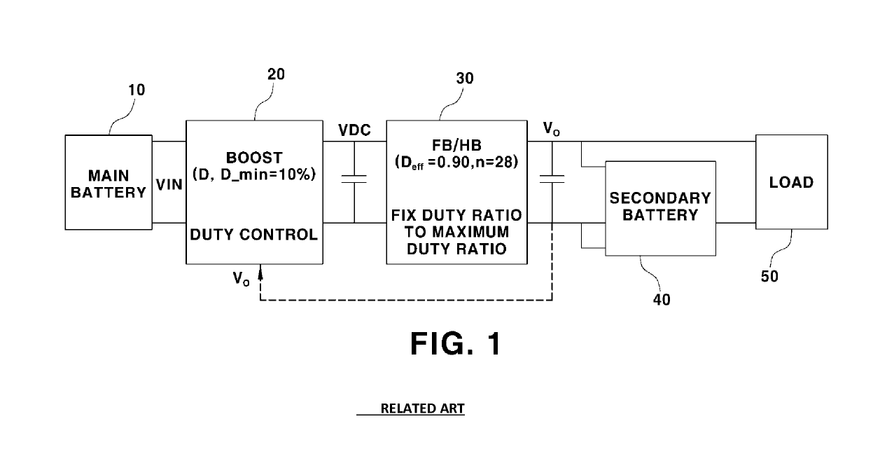

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles, fuel cell vehicles, and other alternative fuel vehicles (e.g., fuels derived from resources other than petroleum). As referred to herein, a hybrid vehicle is a vehicle that has two or more sources of power, for example both gasoline-powered and electric-powered vehicles.

Additionally, it is understood that the term controller/control unit refers to a hardware device that includes a memory and a processor. The memory is configured to store the modules and the processor is specifically configured to execute said modules to perform one or more processes which are described further below.

Furthermore, control logic of the present invention may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Hereinafter, the present invention will be described in detail with reference to the accompanying drawings to allow those of ordinary skill in the art to easily carry out the present invention. To facilitate understanding of the present invention, a duty and a duty ratio which have the same meaning will be used together.

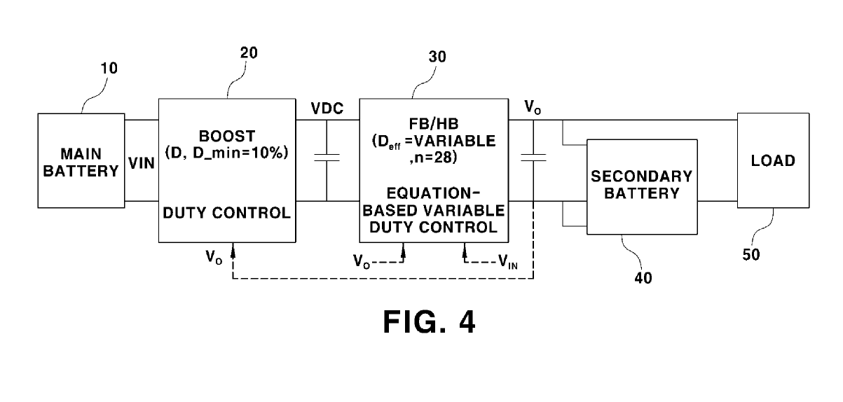

Referring to FIG. 4, in a Low-Voltage DC-DC Converter (LDC) to which a variable duty control method according to an exemplary embodiment of the present invention is applied, a boost converter 20 connected with a main battery 10 to supply a boost voltage to a load 50 and a full bridge (FB) converter 30 or a half bridge (HB) converter connected with the boost converter 20 by a switch 32 to output a transformed and rectified voltage to a secondary battery 40 or the load 50 may be combined.

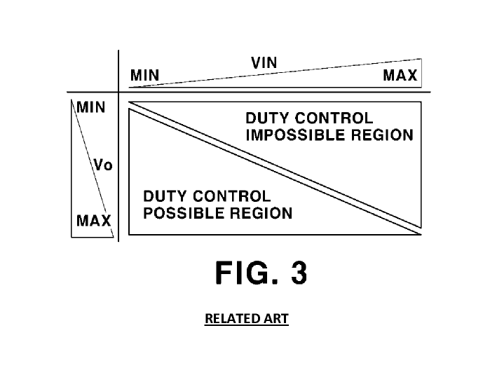

As illustrated in FIG. 3, the FB converter 30 may include the switch 32 configured to alternately switch and output DC, a transformer 34 configured to decrease an AC voltage output from the switch 32 to a 12V level available in the vehicle, and a rectifier 36 configured to rectify the decreased voltage to a predetermined voltage.

Herein, to facilitate understanding of the present invention, a conventional duty control example of an LDC will be described below. Conventional duty control adopts a one-stage duty control scheme which duty-controls an output voltage of the boost converter when the output voltage of the FB converter is fixed to a maximum duty D_{eff}_{_{—}}_{MAX}. Further, to the boost converter 20, an input voltage V_{IN} from the main battery 10 and a current output voltage V_{O} of the FB converter 30 may be input.

An output voltage VDC of the boost converter may be calculated and output using Equation 1, and the output voltage V_{O} of the FB converter may be calculated and output using Equation 2.

VDC=V_{IN}/(1−D) (1)

wherein V_{DC} indicates the output voltage of the boost converter, V_{IN} indicates the input voltage, and D indicates a duty (ratio).

V_{O}=VDC*Deff_MAX/n (2),

wherein V_{O} indicates the output voltage of the FB converter, D_{eff}_{_{—}}_{MAX} indicates a maximum duty (ratio), and n indicates the number of turns of a coil of the transformer of the FB converter.

Therefore, the maximum duty D_{eff}_{_{—}}_{MAX} of the FB converter may be a fixed ratio and thus conventional duty control may adopt a one-stage duty control scheme that controls only a duty D ratio of the boost converter. Therefore, the duty D of the boost converter for the one-stage duty control may be expressed in Equation 3 as follows:

D=1−(D_{eff}_{_{—}}MAX)*(V_{IN}/V_{O}) (3)

As an example of conventional duty control, when the maximum fixed duty D_{eff}_{_{—}}_{MAX} of the FB converter is about 0.9 (90%), the number of turns of a coil of the transformer of the FB converter 30, n, may be about 28 (e.g., a fixed value although may vary according to a type of the converter), the input voltage V_{IN} from the main battery may be about 300V, the output voltage V_{O} of the FB converter may be about 12.8V, and these value may be input to Equation 3, to calculate the duty D of the boost converter as about 0.25 which is greater than D_min Therefore, the output voltage V_{O} may be about 12.8V with respect to the input voltage V_{IN} of about 300V through control of the duty D of the boost converter, allowing low-voltage output to be performed.

For reference, the output voltage V_{O} may be output as a low voltage of about 12V to satisfy a required voltage for various electric field loads of the hybrid electric vehicle and a charging voltage for the 12V secondary battery. However, as another example of conventional duty control, when the maximum duty D_{eff}_{_{—}}_{MAX} of the FB converter is about 0.9 (90%), the number of turns of the coil of the transformer of the FB converter, n, may be about 28 (e.g., a fixed value although may vary according to a type of the converter), the input voltage V_{IN} from the main battery may be about 400V, the output voltage V_{O} of the FB converter may be about 12.8V, and the values may be input to Equation 3, to calculate the duty D of the boost converter as about −0.0045 which is less than D_min Therefore, as the input voltage VIN increases to about 400V, the duty control ratio of the boost converter may become about −0.0045 which is less than the minimum duty D_min, preventing duty control and thus for a high input voltage, low-voltage output may not be possible, thus failing to generate a desired output voltage.

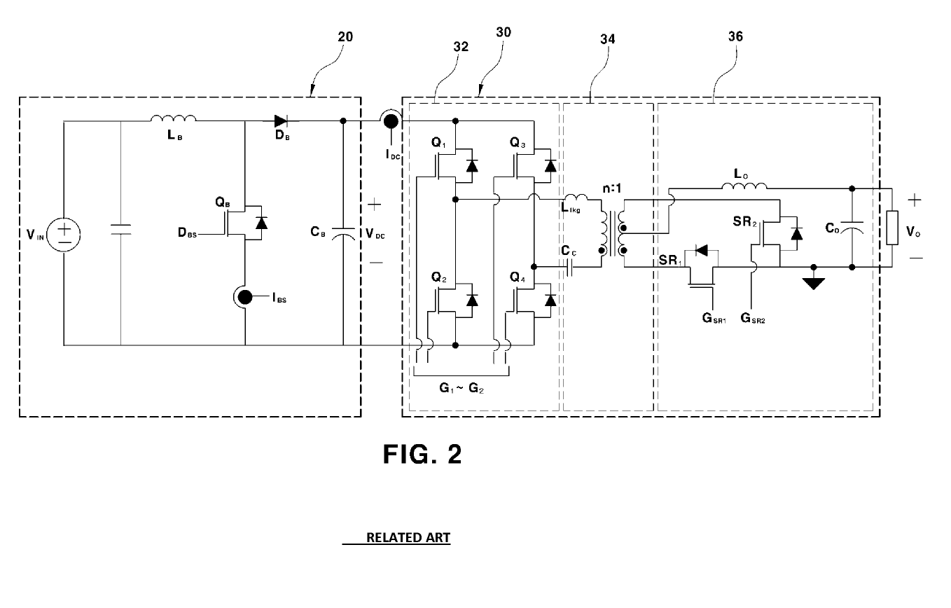

Referring to FIG. 2, conventionally, as the input voltage V_{IN} decreases, the control possible region in which duty control is possible increases, but as the input voltage V_{IN} increases, the control impossible region in which duty control is impossible, increases, thus preventing an output voltage of a desired low voltage to be generated for a high input voltage.

The present invention is intended to solve the foregoing problem, and is mainly characterized by variable-controlling a duty ratio for the output voltage of the FB converter.

Herein, a duty control method for an LDC according to an exemplary embodiment the present invention will be described below.

In particular, duty control of the LDC according to an exemplary embodiment of the present invention controls (e.g., maintains) and outputs the output voltage VDC of the boost converter to a duty ratio in a predetermined range, and controls and outputs the output voltage V_{O} of the FB converter to a variable-open-loop duty ratio that corresponds to the input voltage V_{IN} and the output voltage V_{O}. As illustrated in FIG. 4, the input voltage VIN from the main battery 10 and the current output voltage V_{O} of the FB converter 30 may be input to the boost converter 20, and the input voltage V_{IN} and the current output voltage V_{O} may be input to the FB converter 30.

When the input voltage VIN for the boost converter 20 and the FB converter 30 is substantially low, duty control may be performed to maintain the output voltage V_{DC} of the boost converter at a duty ratio in a predetermined range and the output voltage V_{O} of the FB converter may be fixed to the maximum duty D_{eff}_{_{—}}_{MAX}. Therefore, when the input voltage V_{IN} is substantially low, as described in the conventional duty control example, the output voltage V_{O} that is less than the input voltage V_{IN} may be output to the load or the secondary battery.

According to the exemplary embodiment of the present invention, when the input voltage V_{IN} increases, the output voltage V_{DC} of the boost converter may be fixed to a duty ratio (e.g., a minimum duty) in a predetermined range, and as the maximum duty of the FB converter varies with the increasing input voltage V_{IN}, the duty ratio of the boost converter may be determined by closed-loop control and the output voltage V_{O} of the FB converter may be controlled to a simple-equation-based variable duty ratio.

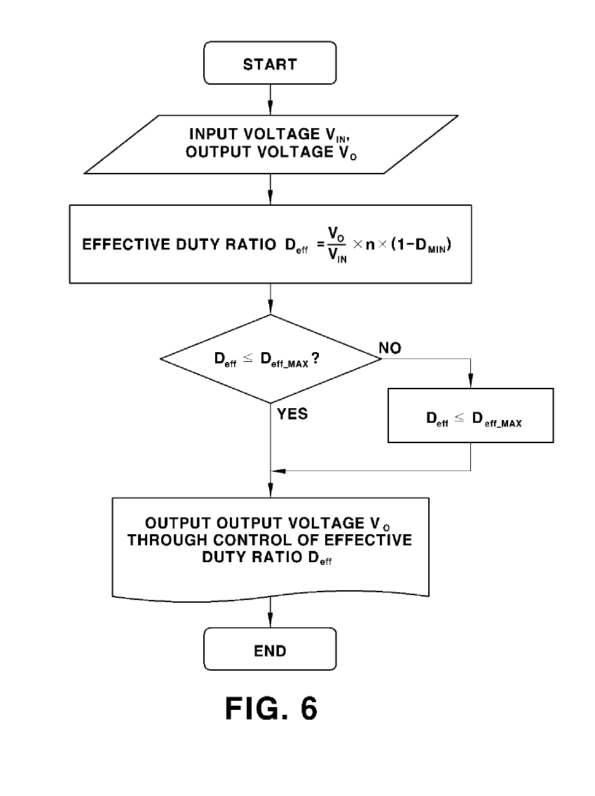

Further, referring to the flowchart of FIG. 6, the current input voltage V_{IN} and the output voltage V_{O} may be input to the FB converter, and through a process of calculating an effective duty ratio D_{eff} of the FB converter for variable duty control for the input voltage V_{IN} and the output voltage, the final output voltage V_{O} may be output to the secondary battery or the load using Equation 4 and Equation 5 below.

$$\begin{matrix}{V}_{DC} = \frac{{V}_{IN}}{1 - D} , & ( 4 ) \\ {V}_{O} = {V}_{DC} \frac{{D}_{eff}}{n} , & ( 5 )\end{matrix}$$

wherein V_{DC} indicates the output voltage of the boost converter, V_{IN} indicates the input voltage, D indicates a duty (ratio), D_{eff} indicates an effective duty ratio, and n indicates the number of turns of the coil of the transformer of the FB converter.

The effective duty ratio D_{eff} is a result of calculation of a duty ratio that may be maximal for each of the input voltage and the output voltage using Equation 4 which is an input-output equation of the boost converter and Equation 5 which is an input-output equation of the FB converter, and may be expressed using Equation 6 below, in which the duty ratio D of the boost converter and the effective duty ratio D_{eff} of the FB converter may exist in a predetermined range.

$${D}_{eff} = \frac{{V}_{O}}{{V}_{IN}} \times n \times ( 1 - {D}_{MIN} ) , \qquad ( 6 )$$

wherein V_{IN} indicates the input voltage, V_{O} indicates the output voltage, D_{MIN} indicates the available minimum duty (ratio) of the boost converter, D_{eff} indicates an effective duty ratio, and n indicates the number of turns of the coil of the transformer of the FB converter.

However, conditions of D_{MIN}≦D<1 and 0<D_{eff}≦D_{eff}_{_{—}}_{MAX} should be satisfied. After the effective duty ratio Deff is calculated using Equation 6, the calculated effective duty ratio D_{eff} may be compared with the maximum effective duty ratio D_{eff}_{_{—}}_{MAX}; when the effective duty ratio D_{eff} is less than or equal to the maximum effective duty ratio D_{eff}_{_{—}}_{MAX}, the output voltage V_{O} of the FB converter may be controlled and output to the effective duty ratio D_{eff}.

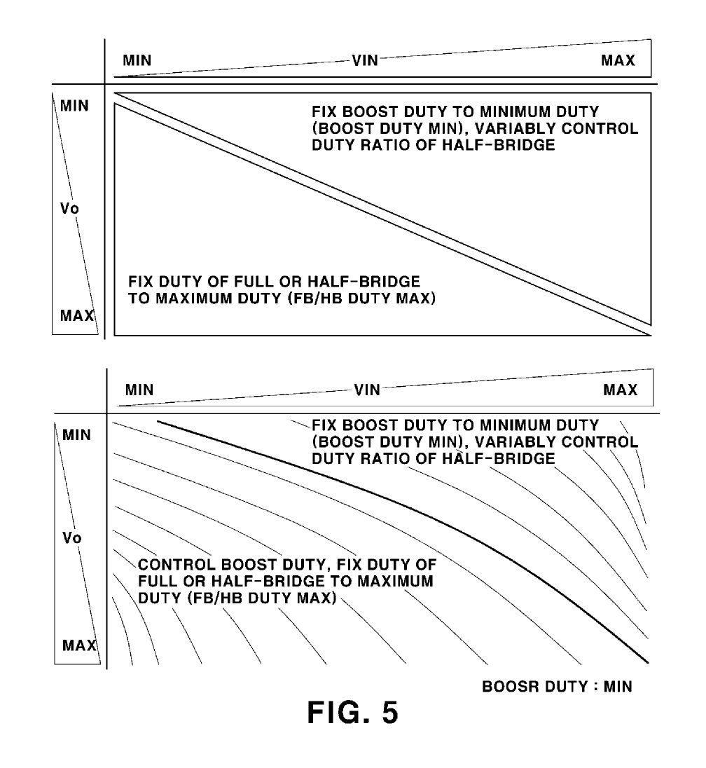

Therefore, when the input voltage V_{IN} for the boost converter 20 and the FB converter 30 is substantially low, the output voltage V_{O} of the FB converter 30 may be fixed to the maximum fixed duty D_{eff}, and the output voltage V_{DC} of the boost converter 20 may be controlled to a duty ratio in a predetermined range. In addition, when the input voltage V_{IN} is substantially high, the output voltage V_{DC} of the boost converter 20 may be controlled to the minimum duty ratio in a predetermined range and simultaneously, the output voltage V_{O} of the FB converter 30 may be controlled to a simple-equation-based variable duty ratio, causing the entire output voltage range to become a duty-control possible region as illustrated in FIG. 5, and thus low-voltage output may be possible over substantially the entire output voltage range.

Herein, an experimental example of a duty control method for an LDC according to an exemplary embodiment of the present invention will be described. In particular, when the input voltage V_{IN} from the main battery is substantially low, such as about 300V, the effective duty ratio D_{eff} of the FB converter may be about 0.9 (90%), the number of turns of the coil of the transformer of the FB converter 30 may be about 28 (e.g., a fixed value although may vary according to a type of the converter), the output voltage V_{O} of the FB converter may be about 12.8V, and these value may be input to Equation 3, then the duty D of the boost converter may be calculated to be about 0.25 which is greater than the minimum duty D_min. Therefore, through control of the duty ratio D of the boost converter, for the input voltage V_{IN} of about 300V, the output voltage V_{O} may be abouts 12.8V, thus achieving low-voltage output.

Furthermore, when the input voltage V_{IN} from the main battery is substantially high, such as about 400V, the number of turns of the coil of the transformer of the FB converter 30 may be about 28 (e.g., a fixed value although may vary according to a type of the converter), and the output voltage V_{O} of the FB converter may be about 12.8V, the effective duty ratio D_{eff} of the FB converter may be variable-controlled, and thus, the duty ratio D of the boost converter may be fixed to the minimum duty ratio D_{MIN}. Therefore, when the input voltage V_{IN} of about 400V, the number of turns of the coil of the transformer, n, of about 28, the output voltage V_{O} of the FB converter of about 2.8V, and the minimum duty ratio D_{MIN} of the boost converter of about 0.1 (10%) may be input to Equation 6 to calculate the effective duty ratio D_{eff} of the FB converter as about 0.81.

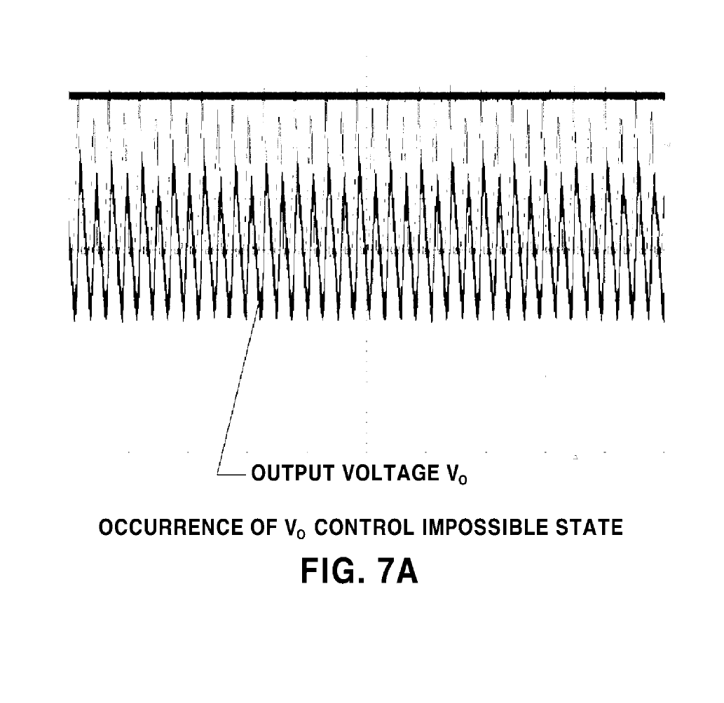

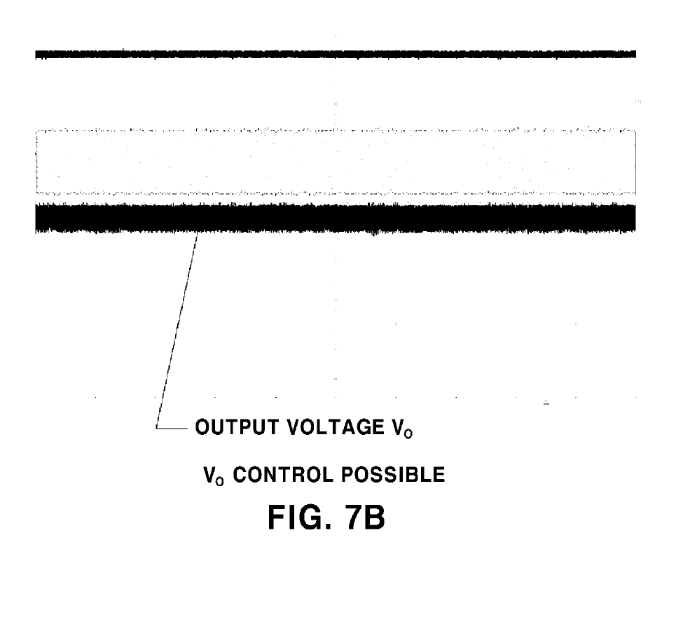

Referring to the waveform diagrams of FIGS. 7A and 7B illustrating the result of the experimental example according to an exemplary embodiment of the present invention, when the duty ratio of the FB converter is fixed to the maximum duty ratio as in a conventional case, as illustrated in the waveform diagram of FIG. 7A, the waveform of the output voltage V_{O} may be in a control-impossible state in which an amplitude is substantially large. However, when the duty ratio of the FB converter is variable-controlled to an effective duty ratio as in the present invention, the output voltage V_{O} may be output constant as illustrated in the waveform diagram of FIG. 7B.

As described above, by controlling and outputting the output voltage of the FB converter with a simple-equation-based variable-duty scheme as a duty-control scheme for an LDC in which the boost converter and the FB or HB converter are combined according to an exemplary embodiment of the present invention, stable low-voltage output may be achieved over substantially the entire input/output voltage range.

Through the foregoing problem-solving means, the present invention provides the following effects. By controlling and outputting the output voltage of the FB converter with a simple-equation-based variable-duty scheme as a duty-control scheme for an LDC in which the boost converter and the FB or HB converter are combined, low-voltage output may be possible for a substantially high input voltage and thus stable low-voltage output may be performed over substantially the entire input/output voltage range. Moreover, for a substantially high input voltage, low-voltage output may be possible and thus a desired output voltage may be generated, to secure stability of control of the DC-DC converter over substantially the entire input/output voltage range.

While the exemplary embodiment of the present invention has been described in detail, the scope of the present invention is not limited to the foregoing exemplary embodiment and various modifications and improves made by those of ordinary skill in the art using the basic concept of the present invention defined in the appended claims are also included in the scope of the present invention.

Description of Reference Numerals

| | |
|---|---|
| 10: MAIN BATTERY | 20: BOOST CONVERTER |
| 30: FULL-BRIDGE CONVERTER | 32: SWITCH |
| 34: TRANSFORMER | 36: RECTIFIER |
| 40: SECONDARY BATTERY | 50: LOAD |

What is claimed is:

1. A duty control method for a low-voltage DC-DC converter (LDC), comprising:
closed-loop controlling and outputting, by a boost converter, output voltage (V_{O}) of the LDC to a duty ratio in a predetermined range of the boost converter; and
variable-open-loop controlling and outputting, by a full-bridge (FB) converter or a half-bridge (HB) converter, the V_{O} of the FB converter to a variable-open-loop duty ratio that corresponds to an input voltage (V_{IN}) and the V_{O}, wherein the V_{IN} is boosted by the boost converter from a main battery.

2. The duty control method of claim 1, wherein when the V_{IN} is substantially low, an output voltage (V_{DC}) of the boost converter is controlled to a duty ratio in a predetermined range and the V_{O} of the FB converter is fixed to a maximum duty (D_{eff}_{_{—}}_{MAX}).

3. The duty control method of claim 1, wherein when the V_{IN} increases, the V_{O} of the FB converter is controlled to a variable-open-loop duty ratio, and as a duty of the FB converter varies with the increasing input voltage, the duty ratio of the boost converter is determined by closed-loop control.

4. The duty control method of claim 3, wherein controlling to the variable-open-loop duty ratio includes, as an equation-based variable duty control process:
inputting, by a processor, the current input voltage (V_{IN}) and the output voltage (V_{O}) to the FB converter;
calculating, by the processor, the effective duty ratio (D_{eff}) of the FB converter for variable duty control that corresponds to the input voltage (V_{IN}) and the output voltage (V_{O}); and
controlling and outputting, by the processor, the output voltage (V_{O}) of the FB converter to the effective duty ratio (D_{eff}) when the effective duty ratio (D_{eff}) is less than or equal to the maximum effective duty ratio (D_{eff}_{_{—}}_{MAX}).

5. The duty control method of claim 4, wherein the effective duty ratio (D_{eff}) is calculated as:
$${D}_{eff} = \frac{{V}_{O}}{{V}_{IN}} \times n \times ( 1 - {D}_{MIN} )$$
and calculated as an equation-based duty ratio that is maximal for each input voltage and output voltage from
$${V}_{DC} = \frac{{V}_{IN}}{1 - D}$$
$$and$$
$${V}_{O} = {V}_{DC} \frac{{D}_{eff}}{n}$$
that are input/output equations between the boost converter and the FB converter,
wherein V_{IN} indicates the input voltage, V_{O} indicates the output voltage, D_{MIN} indicates the available minimum duty (ratio) of the boost converter, D_{eff} indicates an effective duty ratio, and n indicates the number of turns of the coil of the transformer of the FB converter.

6. A system for duty controlling a low-voltage DC-DC converter (LDC), the system comprising:
a processor coupled to the network interfaces and adapted to execute one or more processes; and
a memory configured to store a process executable by the processor, the process when executed operable to:
input a current input voltage (V_{IN}) and a output voltage (V_{O}) to a full-bridge (FB) converter;
calculate an effective duty ratio (D_{eff}) of the FB converter for variable duty control that corresponds to the input voltage (V_{IN}) and the output voltage (V_{O}); and
control and output the output voltage (V_{O}) of the FB converter to the effective duty ratio (D_{eff}) when the effective duty ratio (D_{eff}) is less than or equal to the maximum effective duty ratio (D_{eff}_{_{—}}_{MAX}).

7. The system of claim 6, wherein the effective duty ratio (D_{eff}) is calculated as:
$${D}_{eff} = \frac{{V}_{O}}{{V}_{IN}} \times n \times ( 1 - {D}_{MIN} )$$
and calculated as an equation-based duty ratio that is maximal for each input voltage and output voltage from
$${V}_{DC} = \frac{{V}_{IN}}{1 - D}$$
$$and$$
$${V}_{O} = {V}_{DC} \frac{{D}_{eff}}{n}$$
that are input/output equations between the boost converter and the FB converter,
wherein V_{IN} indicates the input voltage, V_{O} indicates the output voltage, D_{MIN} indicates the available minimum duty (ratio) of the boost converter, D_{eff} indicates an effective duty ratio, and n indicates the number of turns of the coil of the transformer of the FB converter.
